(19) United States
(12) Patent Application Publication
(10) Pub. No.: US 2014/0234892 A1
(43) Pub. Date: Aug. 21, 2014

(54) MICROFLUIDIC DEVICE FOR SEPARATING CELLS FROM A FLUID

(71) Applicant: Siemens Healthcare Diagnostics Inc., Tarrytown, NY (US)

(72) Inventor: Michael Pugia, Granger, IN (US)

(73) Assignee: SIEMENS HEALTHCARE DIAGNOSTICS INC., Tarrytown, NY (US)

(21) Appl. No.: 14/346,660

(22) PCT Filed: Sep. 21, 2012
(86) PCT No.: PCT/US2012/056679

§ 371 Date: Mar. 21, 2014

Related U.S. Application Data
(60) Provisional application No. 61/538,165, filed on Sep. 23, 2011.

(51) Int. Cl. B01L 3/00; G01N 1/40

(52) U.S. Cl. CPC B01L 3/502753; G01N 1/4077
USPC 435/30; 435/309.1

(57) ABSTRACT

A microfluidic device for separating one or more cells having a diameter and a first surface energy from a bulk fluid having a second surface energy. The microfluidic device has a base portion having a capillary gap with an inlet capillary, an outlet capillary, a bottom surface, a gap height with the ratio of the gap height to the diameter of the one or more cells ranging from 5 to 1 to 100 to 1. The base portion defines a first flow path therethrough, at least one groove formed in the bottom surface of the capillary gap, the at least one groove having a depth, a width, and a third surface energy, and oriented perpendicular relative to the first flow path. The ratio of the groove width to the diameter of the one or more cells ranges from about 5 to 1 to about 100 to 1, and the third surface energy is higher than the first and second surface energies.

### CROSS-REFERENCE TO RELATED APPLICATION

The present application is based on provisional application Ser. No. 61/538,165, filed Sep. 23, 2011, the entire contents of which are herein incorporated by reference.

### BACKGROUND OF THE INVENTIVE CONCEPTS

1. Field of the Inventive Concepts

The inventive concepts disclosed and claimed herein generally relate to microfluidic devices, and more particularly, but not by way of limitation, to a microfluidic device for separating one or more cells from a bulk sample containing cells.

2. Brief Description of Related Art

Cellular analysis is important in medical applications, such as diagnosis of many diseases. However, many medical applications of cellular analysis require isolation of certain cells of interest which typically represent only a small fraction of the analyzed sample. For example, circulating tumor cells (hereinafter referred to as “CTC”) are of particular interest in the diagnosis of metastatic cancers. In conventional methods, CTC are isolated from whole blood by first removing red blood cells by lyses. In a 10 milliliter (ml) blood sample, a few hundred CTC are to be separated from about 800,000,000 white blood cells (hereinafter “WBC”). This requires methods with high separation efficiency and cell recovery rates.

For rare cells to be analyzed by conventional scanning microscopy methods, WBC are typically reduced to one to two million cells and the sample volume is reduced from 10 ml to fractions of a microliter (μl). The reduction in volume allows for a reduction of the area to be scanned by the microscope. A typical scanning microscope with a high power field at 400× magnification covers about 0.2 μl of sample, and may require capturing ten or more images to cover the entire sample field. This results in even a small 151 μl sample typically requiring upwards of six thousand images to capture the entire sample field. A distinct disadvantage of such large number of captured images is the extended time for analysis of the data despite some process automation existing in the prior art.

Several approaches have been developed to date to capture and/or isolate CTC. One approach is to deplete the WBC from a whole blood sample (i.e., negative depletion). Another approach is to enrich the CTC in a whole blood sample (i.e., positive enrichment). Both of the above approaches may rely on a variety of techniques, such as magnetic particles, filtration, flow cytometry, and microfluidic channels and chambers, to conduct the rare cell analysis.

Microfluidic channels and chambers are typically interconnected to construct microfluidic devices (hereinafter referred to as “microfluidic chips”), which operate based on capillary and/or centrifugal forces, and typically without using electrical fields. Such microfluidic chips have been shown to be a precise method for processing biological samples. See for example U.S. Pat. No. 7,459,127, the entire disclosure of which is hereby incorporated herein by reference. The geometry of the channels in a microfluidic chip can be designed to allow for stopping/starting flows, multiplexing fluids, mixing and various other operations. Additionally, the geometry of microstructures within the channels and chambers can have an impact on the operation of a microfluidic chip. Microstructures such as post, veers, ramps, grooves, speed bumps, and other structures, have been described for the purposes of directing flow of air, fluid, and biological fluids in microfluidic chips. See for example U.S. patent application Ser. Nos. 10/608,671, and 10/608,400, the entire contents of which are hereby incorporated herein by reference.

Microstructure posts have been recently described and implemented for the purposes of directing flow in devices for collecting cells, such as rare cells. However, in general, adhesion of cells to a microstructure post in a capillary gap is non-selective and does not differentiate between cell types. Adhesion of cells to microfluidic chip surfaces may occur when such chip surfaces are coated with affinity reagents, such as antibodies and other binding molecules, to attract and retain specific cell types. In all these cases, the microstructure serve only as flow resistance to cause disruption fluid, causing a mixing surface function, so called “boulders in the stream.” Separation is not due to specific physical attraction between the microstructure and a cell but to affinity reagent on the surface. In fact, it has recently been shown that a herringbone microstructure groove when used to replace the post causes mixing and capture occurs both inside and outside the groove.

Microfluidics has also been applied to separate specific types of cell from a bulk fluid sample by using a principle of surface adhesion in a capillary gap (see for example U.S. Pat. No. 7,094,354, the entire disclosure of which is incorporated herein by reference). This principle relies on adjusting the surface energy of the microfluidic chip surface relative to the surface energy of the bulk fluid and the cells of interest. Cells will adhere to higher energy surfaces (hydrophilic surfaces) in a capillary gap, when the ratio of the gap height to the diameter of the cell is in a range from about 5/1 to about 100/1. This principle may operate under only capillary force, or under low centrifugal force, pressurized flow, or electromagnetic forces. The capillary gap height must not be greater than five times the cell diameter as to block particles from passing under low flow limiting fluid flow. The capillary gap width and length can be varied to accept the amount of fluid to be separated. Adhesion increases as the gap height approaches the cell diameter and as the gap surface energy becomes higher relative to the cell and/or fluid surface energy. Excessive adhesion can cause cell lysis (which results in cell loss), while weak adhesion does not stop cells from flowing through the gap. However, adhesion can be adjusted for a certain cell type, based on the cell diameter and cell surface energy, for example.

Recently, small capillaries with a ratio of capillary gap height to cell diameter of less than three and side walls about the diameter of the cell have been used to pass cells across affinity reagents. Cells are not trapped in these tiny capillaries without affinity reagents. Additional studies of nanoparticles behavior has shown that when particles are flowed across a grooved chamber that the particles develop a rotational flow inside the groove. This rotational flow demonstrated that particles are not trapped inside the groove but are instead mixed. The behavior was demonstrated at 0.5 micrometer (μm) particle diameter and to 125 μm capillary gaps in the groove (ratio of particle diameter to capillary gap height greater than 250). The same general principle is also believed to be applicable to cells flowing across a grooved chamber.

Once one or more cells of interest are separated from a sample (also referred to as “captured” and/or “trapped” hereinafter), the cells may be reacted with reagents for detection (e.g., labels and probes) or biomarkers, for example. This so called “staining and/or labeling” is another important feature of clinical analysis of cells of interest.

Thus, a need exists for a microfluidic device and method that allows selective capture of cells, reaction of the captured cells with detection reagents, and isolation of the captured cells, without the use of affinity reagents. It is to such a microfluidic device and method that the inventive concepts disclosed and claimed herein are directed.

### SUMMARY OF THE INVENTIVE CONCEPTS

The inventive concepts disclosed and claimed herein generally relate to use of microfluidic devices with capillary gaps having one or more grooves perpendicular to capillary flow formed therein and of a certain surface energy and width ratio in relationship to the diameter of the cells to be captured. Such microfluidic device design may allow for selective capture of rare cells, reaction of captured cells with detection reagents, and capture and/or isolation of rare cells without affinity reagent used for capture, for example.

The principle of surface adhesion in a capillary gap operates in grooves formed in the bottom of a capillary gap when such grooves are perpendicular to the flow path of the sample fluid through the capillary gap. As used herein the term perpendicular is not limited to precisely 90°, but may accommodate small deviations therefrom due to measurement error, measurement method precision, shape of the fluid meniscus as the fluid initially flows through the capillary gap, and tolerances and imperfections resulting from the microfluidic device manufacturing process, for example.

Cells adhere into a groove when the surface energy (e.g., hydrophilic surfaces) of the groove is adjusted for adhesion, and the ratio of the groove width to the diameter of the cell ranges from about 5/1 to about 100/1. The groove width is defined as being in the direction of the fluid flow path inside the capillary gap. The grooves can have varying depth (distance below the bottom of capillary gap) and width (length across the capillary gap) depending, for example, on the amount of cells to be separated from the bulk fluid and captured inside the grooves.

This method is selective as adhesion can be adjusted for a cell type based on the cell diameter and the cell surface energy. For example, for cells having a relatively large diameter, a groove having a relatively large width (desirably within the above ratio from 5/1 to 100/1, for example) may be used. Further, for a sample of bulk fluid containing a large number of cells to be captured, a deeper groove may be used, for example.

Additionally, it was found that the ends of one or more of the grooves may be connected to one or more capillaries, and the one or more capillaries may be used to flush additional fluids through one or more of the grooves, in a flow path perpendicular to the original flow path of the sample (or bulk) fluid, to flush captured cells out of one or more of the grooves and into a second capillary gap, for example. This principle allows sequential processing needed for reacting captured cells with reagents for detection, for example, by connecting two or more microfluidic devices, or by implementing a single microfluidic device with two or more capillary gaps. Additionally the instant inventive concept can be used to isolate and remove one or more individual cells of interest via a cell isolation port in fluid communication with one or more groove as will be described herein below, for example.

One embodiment of the inventive concepts disclosed and claimed herein comprises a microfluidic device having one or more base portions defining a capillary gap with a ratio of the capillary gap height to the diameter of the cells of interest ranging from about 5/1 to about 100/1, and a first surface energy relatively higher compared to a relatively lower surface energy of the bulk fluid and the cells of interest, such that the cells of interest will tend to adhere to the higher surface energy surface of the capillary gap. The bottom surface of the capillary gap comprises one or more grooves perpendicular to a fluid flow path and having a width measured along the fluid flow path, where the ratio of the groove width to the diameter of the cell ranges from 5/1 to 100/1.

In another aspect, the inventive concepts disclosed and claimed herein relate to using a microfluidic device to capture, isolate, and process cells of interest with agents such as detection reagents, or other chemicals, for example. In this embodiment, one end of a groove is in fluid communication with a flush capillary, and the flush capillary is used to flow a flush fluid through the groove and flush cells out of the groove and into an exit capillary. Additional microfluidic devices may be fluidly connected to one another in sequential processing, where each microfluidic device defines a capillary gap which has a flow path oriented at 90 degrees from the flow path of an adjacent microfluidic device(s).

In some embodiments the cells may be detected in the grooves of the microfluidic device by using detection reagents, or flushed into another capillary gap for cell imaging as will be described below, for example.

The inventive concepts disclosed and claimed herein also relate to using a microfluidic device to capture and isolate certain cells of interest from a sample or bulk fluid. An exemplary embodiment comprises a feed capillary connected to one end of a groove formed in the bottom of a capillary gap, which feed capillary is used to flow an additional flush fluid through the groove and flush cells out of groove into an exit capillary where the exit capillary has a cell isolation port configured to allow for the isolation and/or removal of one or more individual cells.

### BRIEF DESCRIPTION OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. The figures are not necessarily the scale and certain features and certain views of the figures may be shown exaggerated and scale or in schematic in the interest of clarity and conciseness. In the drawings:

FIG. 1A is a top plan view of an embodiment of a microfluidic device constructed in accordance with the inventive concepts disclosed herein.

FIG. 1B is a sectional view taken along line 1B-1B of FIG. 1A.

FIG. 2 is a diagrammatic view illustrating use of the microfluidic device of FIG. 1A.

FIG. 3 is a top plan view of another embodiment of a microfluidic device constructed in accordance with the inventive concepts disclosed herein.

FIG. 4 is a diagrammatic view illustrating use of the microfluidic device of FIG. 3.

FIG. 5 is a top plan view of another embodiment of a microfluidic constructed in accordance with the inventive concepts disclosed herein

FIG. 6A is a top plan view of another embodiment of a microfluidic device having cell isolation ports.

FIG. 6B is a sectional view taken along line 6B-6B of FIG. 6A.

FIG. 6C is a sectional view taken along line 6C-6C of FIG. 6A.

### DETAILED DESCRIPTION OF EXEMPLARY EMBODIMENTS

Before explaining at least one embodiment of the inventive concept disclosed herein in detail, it is to be understood that the inventive concept is not limited in its application to the details of construction, experiments, exemplary data, and/or the arrangement of the components set forth in the following description, or illustrated in the drawings. The presently disclosed and claimed inventive concept is capable of other embodiments or of being practiced or carried out in various ways. Also, it is to be understood that the phraseology and terminology employed herein is for purpose of description only and should not be regarded as limiting in any way.

In the following detailed description of embodiments of the inventive concept, numerous specific details are set forth in order to provide a more thorough understanding of the inventive concept. However, it will be apparent to one of ordinary skill in the art that the inventive concept within the disclosure may be practiced without these specific details. In other instances, well-known features have not been described in detail to avoid unnecessarily complicating the instant disclosure.

Further, unless expressly stated to the contrary, or refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or an are employed to describe elements and components of the embodiments herein. This is done merely for convenience and to give a general sense of the inventive concept. This description should be read to include one or at least one and the singular also includes the plural unless it is obvious that it is meant otherwise.

As used herein, the term “affinity reagent” and any variations thereof, is intended to comprise reagents such as antibodies and other binding molecules, used to attract and retain specific cell types. As will be understood by persons of ordinary skill in the art, affinity reagents are typically, but not necessarily, attached to a surface or may attract and retain one or more cells to a surface.

As used herein, the term “detection reagent” and any variations thereof comprises one or more of a first molecule or cell (such as a peptide, an antibody, a nucleic acid, and combinations thereof, for example), which first molecule binds to a second target molecule or cell in order to identify or track such second target molecule or cell. As will be understood by persons of ordinary skill in the art, a detection agent is typically, but not necessarily, unattached to a surface. Further, the same or similar molecules may function as a detection reagent when not attached to a surface, and as an affinity reagent when attached, deposited on, or otherwise connected with, a surface.

As used herein the term “surface energy” and any variations thereof, comprises a measure of the energy required to form a unit area of new surface at the interface between a capillary gap and a fluid. Further, as used herein “surface energy” includes the surface energy of solids and the surface tension of liquids, which may be measured relative to water with a goniometer, for example.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

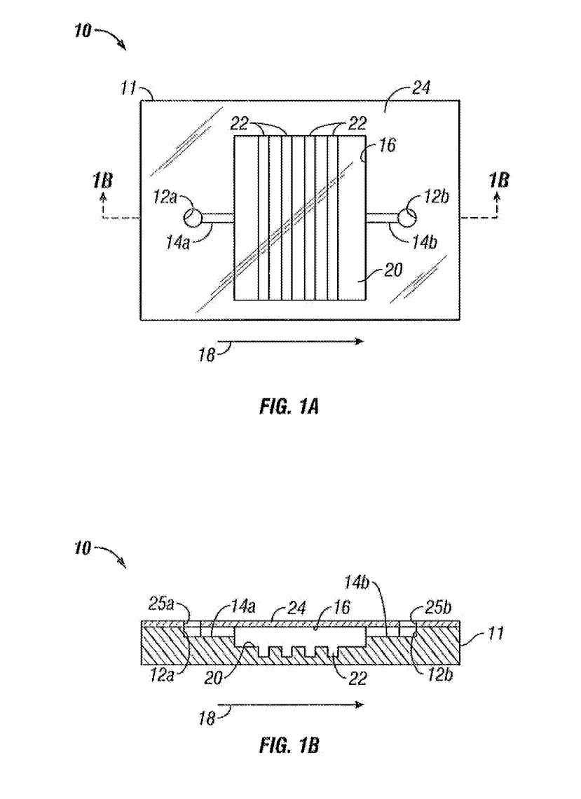

Referring now to the drawings, and more particularly to FIGS. 1A and 1B, shown therein is an exemplary embodiment of a microfluidic device 10 constructed in accordance with the inventive concepts disclosed and claimed herein. The microfluidic device 10 comprises a base portion 11 and a lid or top portion 24. The base portion 11 has an inlet port 12a, an outlet port 12b, an inlet capillary 14a, an outlet capillary 14b, and cooperates with the top portion 24 to define a capillary gap 16. The capillary gap 16 defines a flow path 18 and has a bottom surface 20 provided with one or more grooves 22. The bottom surface 20 has a first surface energy and the grooves 22 may have a second surface energy. The first surface energy and the second surface energy may be equal or approximately equal to one another, or may be different, as will be understood by a person of ordinary skill in the art. Desirably, the first surface energy and the second surface energy are similar or substantially equal, and are higher than a cell surface energy and a bulk fluid surface energy, as will be described herein below.

The microfluidic device 10 may be referred to as a “chip.” The microfluidic device 10 is generally small and flat, typically about 1 to 2 inches square (25 mm to 50 mm square) or circular discs of similar size (e.g., 25 mm to 120 mm radius).

It will be appreciated that there are several ways in which the ports 12a-12b, the capillaries 14a-14b, and the grooves 22 can be formed in the base portion 11, such as injection molding, laser ablation, diamond milling, embossing, and combinations thereof, for example. Generally, the base portion 11 may be cut to create the desired network of ports 12a-12b, capillaries 14a-14b, and grooves 22, and then the top portion 24 may be positioned onto the base portion 11 to complete the microfluidic device 10.

The top portion 24 includes an inlet portion 25a corresponding to the inlet portion 12a and an outlet port 25b corresponding to the outlet port 12b. The top portion 24 may be transparent to allow for imaging and observation of the sample fluid as it is passed through the microfluidic device 10. The top portion 24 may be secured to the base portion 11 in any suitable manner such as molding, ultrasonic welding, radiofrequency welding, bonding, gluing, and combinations thereof, for example, provided that a substantially fluid-impermeable connection is formed between the base portion 11 and the top portion 24 of the microfluidic device 10.

In one embodiment, the microfluidic device 10 may be disposed of after a single use. Consequently, the microfluidic device 10 is generally made of inexpensive materials to the extent possible, while being compatible with the reagents and the samples which are to be analyzed. By way of example, the microfluidic device 10 may be made of plastics, such as polycarbonate, polystyrene, polyacrylates, or polyurethene, or other materials, such as silicates, silicone, glass, wax, resins, metals, and combinations thereof.

The surface energy of the capillaries 14a and 14b, the grooves 22, and the capillary gap 16 may be adjusted to be either hydrophobic or hydrophilic, properties which are defined with respect to the contact angle formed at a solid surface interface by a liquid sample or reagent. Typically, a surface is considered hydrophilic if the contact angle is less than 90 degrees, and hydrophobic if the contact angle is greater. A surface can be treated to make it either hydrophobic or hydrophilic. In one embodiment, plasma induced polymerization may be carried out at the surface of the passageways. The microfluidic device 10 may also be made with other methods used to control the surface energy of the capillary walls, such as coating with hydrophilic or hydrophobic materials, grafting, or corona treatments, for example. The surface energy of the capillary gap 16 surfaces may be adjusted, i.e., the degree of hydrophilicity or hydrophobicity, for use with the intended sample fluid. As will be understood by persons of ordinary skill in the art, the capillary gap 16 has a plurality of surfaces, including bottom surface 20. Desirably, the surface energy of the bottom surface 20 of the capillary gap 16 is adjusted to be hydrophilic. More desirably, the surface energies of all of the surfaces of the capillary gap 16 are adjusted to be hydrophilic, but it is to be understood that the various surfaces of the capillary gap 16 do not necessarily all have equal surface energies, and do not necessarily all have hydrophilic surface energies, for example. In order to optimize the performance of the device 10, three or more of the surfaces of the capillary gap including the bottom surface 20 are desirably hydrophilic, but a device 10 according to the instant inventive concept may also function with less than three of the surfaces of the capillary gap 16 being hydrophilic, for example.

The capillary gap 16 is shown as being substantially rectangular in form. The capillary gap has a gap height measured from an un-grooved portion of the bottom surface 20 to a capillary surface of the top portion 24, for example. Desirably, the gap height is such that the ratio of the capillary gap height to the diameter of the cells of interest ranges from about 5/1 to about 100/1. It is to be understood, however, that the capillary gap 16 may have a variety of shapes and sizes, such as oval, circular, square, and combinations thereof, for example. It is to be further understood that in some embodiment, the bottom portion 11 and the top portion 24 may be formed as a unitary body, for example. In some exemplary embodiments, the top portion 24 may be omitted.

The outlet capillary 14b may be implemented similarly to the inlet capillary 14a, for example, and is in fluid communication with the capillary gap 16 and the outlet port 12b. The inlet capillary 14a, the capillary gap 16, and the outlet capillary 14b cooperate to define the flow path 18 therethrough. Flow path 18 is shown as being a linear flow path 18, allowing a substantially straight-line flow of fluid therethrough. It is to be understood, however, that the instant inventive concept is not limited to a straight flow path 18 and may comprise a curved, angled, or otherwise non-linear flow path 18. It is to be further understood that a first portion of the flow path 18 may be straight, and a second portion of the flow path 18 may be curved, for example. It is to be further understood that the instant inventive concept is not limited to a single flow path 18, and in some exemplary embodiments the capillary gap 16 may define more than one flow path 18, as will be understood by persons of ordinary skill in the art.

The grooves 22 are shown as being substantially rectangular in configuration and formed in the bottom surface 20 of the capillary gap 16. It is to be understood that while four grooves 22 are shown in FIGS. 1A and 1B, the instant inventive concept is not limited to using four grooves 22, and may comprise any number of grooves 22, such as 1, 2, 3, 5, 100, 200, and a plurality of grooves 22, for example. It is to be further understood that while the grooves 22 are shown as having a substantially rectangular cross-section in FIG. 1B, the instant inventive concept is not limited to grooves 22 of substantially rectangular cross-sections, and may be implemented with grooves 22 having various cross-sections, such as square, triangular, oval, polygonal, circular, irregular, and combinations thereof, for example. In addition, in some exemplary embodiments of the instant inventive concept, grooves 22 may partially or completely span the capillary gap 16, while in other embodiments one or more grooves 22 may completely span the capillary gap 16, and one or more grooves 22 may only partially extend through capillary gap 16.

The grooves 22 have a width measured in the direction of the flow path 18, and a depth measured as the distance between the bottom of the groove 22 and the bottom surface 20 of the capillary gap 16, as will be understood by persons of ordinary skill in the art. The width of the grooves 22 may vary, and may be adjusted for the capture of one or more cells of interest, such that the ratio of the groove width to the diameter of the one or more cells of interest is within a certain predetermined range (e.g., from 5/1 to 100/1). The depth of the grooves 22 may vary depending, for example, on the number of cells to be separated or captured into the grooves 22. Further, in some embodiments where two or more grooves 22 are formed in the capillary gap 16, such two or more grooves 22 may have various depths and widths, for example.

The one or more grooves 22 have a surface energy, which is desirably the same as the surface energy of the bottom surface 20 of the capillary gap 16. However, the one or more grooves may have a surface energy that is similar to, or different from, the surface energy of the bottom surface 20 of the capillary gap 16, for example, as will be understood by persons of ordinary skill in the art.

The one or more grooves 22 are formed into the bottom surface 20 of the capillary gap 16, such that at least one of the one or more grooves 22 is oriented perpendicular to the flow path 18. It is to be understood that as used herein perpendicular is not limited to an angle of precisely 90 degrees, but allows for measurement errors, microfluidic device 10 fabrication imperfections and tolerances, and slight variations due to the shape of the meniscus of the fluid flowing through the capillary gap 16, for example. It is to also be understood that while grooves 22 are shown as being parallel to one another in FIGS. 1A-1B, the instant inventive concept may be implemented with grooves 22 that are not parallel to one another, and that may be oriented at various angles relative to one another, and may even intersect with one another, for example. It is to be further understood that grooves 22 may comprise more than one portion, with a first portion of a first groove 22 being parallel with a first portion of a second groove 22, and a second portion of the first groove 22 angled relative to a second portion of a second groove 22, for example.

It is to be understood that while four grooves 22 are shown in FIGS. 1A and 1B as having the same width and depth, the instant inventive concept is not limited to such exemplary implementation of grooves 22. For example, any number of grooves 22 may be used with the instant inventive concept, and such grooves 22 may have varying depths, widths, and surface energies. As a non-limiting example, an embodiment of a microfluidic device 10 according to the instant inventive concept may comprise one or more grooves 22 having a first width, a first depth, or a first surface energy, and one or more grooves 22 having a second width, a second depth, or a second surface energies. Such grooves 22 may be arranged in various configurations, for example, in order to capture a first cell having a first diameter and a first surface energy, and a second cell having a second diameter and a second surface energy, from a bulk solution.

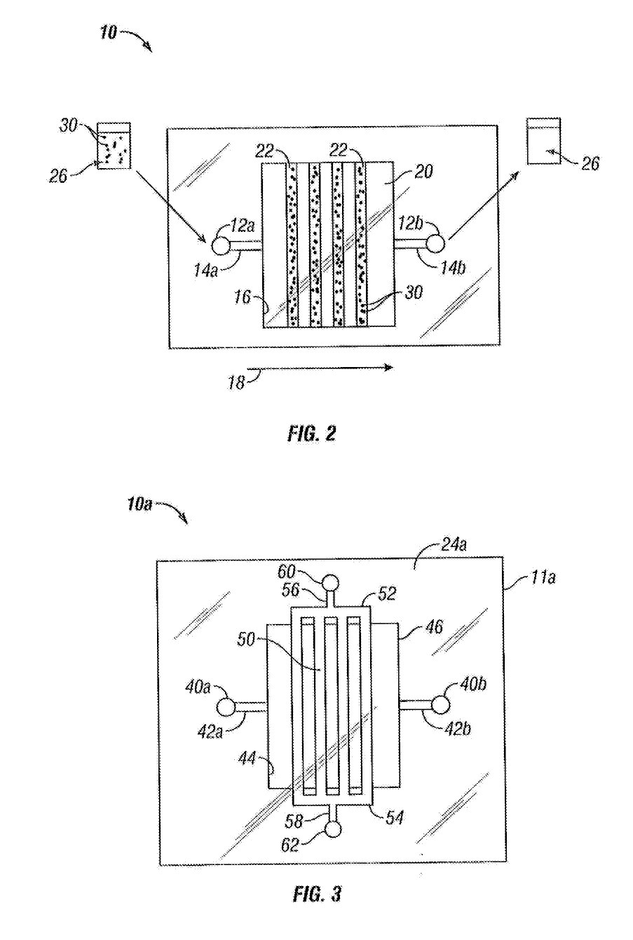

An exemplary embodiment of a method of separating one or more cells 30 from a bulk fluid 26 by passing the bulk fluid 26 through a microfluidic device 10 is shown in FIG. 2. The method comprises passing a bulk fluid 26 comprising one or more cells 30 through the microfluidic device 10 by feeding bulk fluid 26 into the inlet port 12a and flowing the bulk fluid 28 across the inlet capillary 14a and through the capillary gap 16 along the flow path 18. The bulk fluid 26 may be passed through the microfluidic device 10 via capillary flow, or under low gravity force, for example. Further, a pressurized flow may be used to pass the bulk fluid 26 through the microfluidic device 10, with an exemplary flow velocity of about 0.4 millimeters per minute (mm/min). It is to be understood however that such flow velocity is merely exemplary, and the instant inventive concept may be implemented with various flow velocities, such as, for example, flow velocities ranging between 0.01 ml/min and 4 ml/min, depending on sample size as will be appreciated by a person of ordinary skill in the art.

The bulk fluid 26 may be any fluid comprising one or more cells 30, such as a blood sample, a tissue sample, a cell culture, a nutrient broth, an organ sample, a body fluid, and combinations thereof, for example. The bulk fluid 26 has a bulk fluid surface energy, which may be adjusted as needed by, for example, adding surfactants, pH buffers, and various other substances, as will be appreciated by persons of ordinary skill in the art.

The one or more cells 30 have a cell surface energy associated with them, which cell surface energy is desirably lower than surface energy of the capillary gap 16 and/or the grooves 22 as described above. The cell surface energy may be equal to, or similar to, the bulk fluid surface energy, or may be higher or lower than the bulk fluid surface energy. The cell surface energy is desirably lower than the surface energy of the grooves 22 and/or the surface energy of the capillary gap 16.

The one or more cells 30 separate from the bulk fluid 26 by adhering into one or more grooves 22 due to the higher surface energy of the grooves 22, and the bulk fluid 26 exits the microfluidic device 10 via the outlet port 12b. It is to be understood that none, some, or all of the one or more cells 30 may be captured and/or separated from the bulk fluid 26, as will be understood by a person of ordinary skill in the art presented with the instant disclosure.

In the exemplary embodiment shown in FIG. 2, the grooves 22 are perpendicular to the flow path 18 through the capillary gap 16. It is to be understood that in other embodiments, the grooves 22 may not be perpendicular to the flow path 18, but may intersect flow path 18 in a variety of angles, ranging from 0 degrees to 180 degrees. In some exemplary embodiments of the instant inventive concept, the grooves 22 may partially and/or completely define the flow path 18, for example.

The operation of the above exemplary embodiment of a microfluidic device 10 according to the instant inventive concept was demonstrated in series of high speed videos where cells 30 were separated from a bulk fluid 26 comprising cancer cells, red blood cells, and white blood cells. Most cells 30 adhered (or were captured) into the groove 22 when the surface energy of the groove 22 was adjusted for adhesion, and the ratio of the groove 22 width to the diameter of a cell 30 ranges from 5/1 to 100/1. Cells 30 did not effectively adhere (e.g., less than 50% of the cells 30 adhered) when the ratio of the groove 22 width to cell 30 diameter was greater than 100/1 or lower than 5/1, or if the groove 22 surface had a surface energy causing contact angle of greater than 90 degrees relative to water.

Table 1 lists individual geometries of various features, and their functions, in an exemplary embodiment of a microfluidic device 10 comprising two hundred grooves 22. Table 2 lists the size and volume of each of the features shown in Table 1. This exemplary embodiment of a microfluidic device 10 is optimized to separate WBC of approximately 10 μm diameter and cancer cells of approximately 300 μm diameters from a bulk fluid 26 comprising a blood sample. While this exemplary embodiment of microfluidic device 10 only requires capillary action for operation, a pump feeding bulk fluid 26 into inlet port 12a or pulling bulk fluid 26 out of the outlet port 12b can be implemented as well, for example. It is to be understood that centrifugal forces may be used to drive the bulk fluid 26 through a microfluidic device 10 in some embodiments of the instant inventive concept, such as by spinning the microfluidic device inside a centrifuge or other rotating device, for example.

TABLE 1
Exemplary embodiment of microfluidic device 10 features

| Microfluidic | | | | | | Operating |
|---|---|---|---|---|---|---|
| Device | Sub-feature | Id | Shape | Matrix inside | Functions | principle |
| Sample inlet | Inlet port | 12a | Cylinder | Sample bulk | Allows | Capillary |
| feed | | | | fluid 26 | connecting to | action |
| | | | | with one or | pump | |
| | | | | more cells 30 | | |
| | Inlet | 14a | Rectangle | Sample bulk | Connects to | Capillary |
| | capillary | | | fluid 26 | the capillary | action |
| | | | | with one or | gap 16 | |
| | | | | more cells 30 | | |
| WBC capture | Capillary | 16 | Rectangle | Sample bulk | Allows bulk | Capillary |
| capillary gap | gap | | | fluid 26 | fluid 26 to flow | action |
| | | | | with one or | over grooves | |
| | | | | more cells 30 | 22 | |
| WBC capture | WBC | 22 | Rectangle | Sample bulk | Capillary gap | Capillary |
| grooves | capture | | | fluid 26 | 16 for WBC | action |
| | grooves | | | with one or | cell capture | |
| | (spaced at | | | more cells 30 | | |
| | 200 μm) | | | | | |
| Sample | Sample | 14b | Rectangle | Sample bulk | Connects to | Capillary |
| collection | outlet | | | fluid 26 | the capillary | action |
| outfeed | capillary | | | with one or | gap 16 | |
| | | | | more cells 30 | | |
| | | | | removed | | |
| | Sample | 12b | Cylinder | Sample bulk | Allows | Capillary |
| | outlet port | | | fluid 26 with | connecting to | action |
| | | | | one or more | collection | |
| | | | | cells 30 | | |
| | | | | removed | | |

The packing volume for a WBC is 10×10×10 μm. Each groove 22 of the size shown in Table 2 could theoretically contain 12500 WBC, and a microfluidic device 10 with 200 grooves 22 could theoretically remove 2,500,000 cells in one pass through the microfluidic device 10. The microfluidic device 10 requires a minimum volume of bulk fluid 26 to fill the capillary gap 16 (111 μl in the exemplary embodiment of Tables 1 and 2) that is the minimum cell volume.

A greater bulk fluid 26 volume can be passed through the microfluidic device 10. A test with a 3.0 ml sample containing two million cells 30 would only contain forty-six cells 30 (less than 0.001%) after passing through the microfluidic device 10 with a groove cell capture efficiency of 75.85% for each groove 22. The groove cell capture efficiency represents the number of cells 30 packed into a groove 22 divided the maximum number of cells 30 that could be packed into the groove 22. It is to be understood that a microfluidic device 10 with one or more grooves 22 having a groove cell capture efficiency of less than 100%, may have an overall cell capture efficiency approaching 100%, due to the cumulative effect of the groove cell capture efficiencies of the one or more grooves 22, for example.

TABLE 2
Exemplary dimensions of an embodiment of microfluidic device

| | | | | | | | | | Volume |
|---|---|---|---|---|---|---|---|---|---|
| Cell | | | | | | | Drop | | mm\hat{ }3 |
| Capture | Sub- | Width | radius 1 | radius 2 | depth | length | volume | drop | mm³ or |
| Device | feature | mm | mm | mm | mm | mm | PI | number | μl |
| Sample | Sample | 2.000 | 0.500 | na | na | na | Na | na | 1.571 |
| inlet | inlet | | | | | | | | |
| feed | port | | | | | | | | |
| | Sample | 0.500 | na | na | 1.000 | 0.500 | Na | na | 0.250 |
| | inlet | | | | | | | | |
| | capillary | | | | | | | | |
| WBC | WBC | 0.500 | na | na | 5.000 | 40.000 | Na | na | 100.000 |
| capture | capture | | | | | | | | |
| grooves | capillary | | | | | | | | |
| | gap 16 | | | | | | | | |
| | Grooves | 0.050 | na | na | 5.000 | 0.050 | Na | na | 0.013 |
| | (spaced | | | | | | | | |
| | at 200 μm) | | | | | | | | |
| Sample | Sample | 0.500 | na | na | 1.000 | 0.500 | Na | na | 0.250 |
| collection | inlet | | | | | | | | |
| outlet | capillary | | | | | | | | |
| | Sample | 2.000 | 0.500 | na | na | Na | Na | na | 1.571 |
| | outlet | | | | | | | | |
| | port | | | | | | | | |

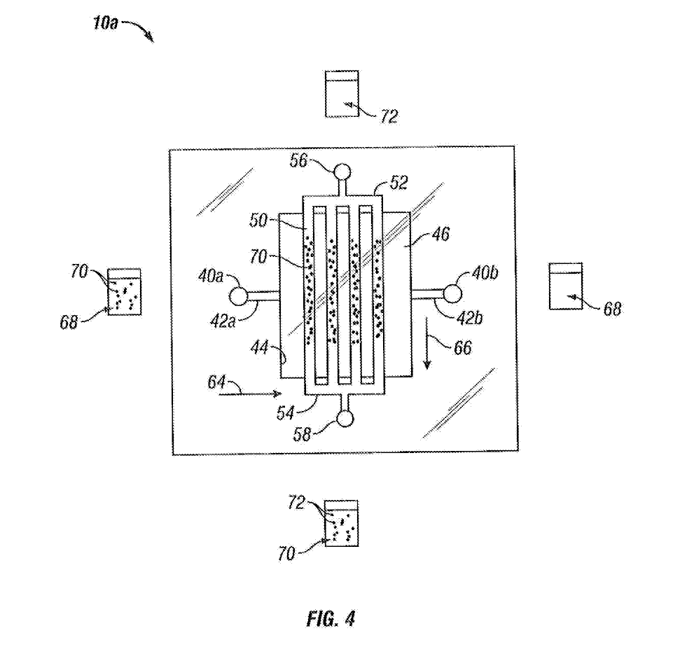

Referring now to FIGS. 3 and 4, another embodiment of a microfluidic device 10a for sequential cell processing is shown. The microfluidic device 10a comprises a base portion 11a and a lid or top portion 24a. The base portion 11a has an inlet port 40a, an outlet port 40b, an inlet capillary 42a, a capillary gap 44 having a bottom surface 46 with one or more grooves 50 formed therein, and an outlet capillary 42b. The grooves 50 have a first end 52 in fluid communication with a flush capillary 56 and a second end 54 in fluid communication with an exit capillary 58. The flush capillary 56 is in fluid communication with a flush port 60 and the exit capillary 58 is in fluid communication with an exit port 62. The bottom surface 46 has a first surface energy, and the grooves 50 may have a second surface energy. The first surface energy and the second surface energy may be equal or approximately equal to one another, or may be different, as will be understood by a person of ordinary skill in the art. Desirably, the first surface energy and the second surface energy are equal, and relate to a cell 70 surface energy with a predetermined ratio as will be described herein below.

The inlet capillary 42a, the capillary gap 44, and the outlet capillary 42b cooperate to define a first flow path 64 therethrough. The first flow path 64 is shown as being a linear flow path 64, allowing a substantially straight-line flow of fluid therethrough. It is to be understood, however, that the instant inventive concept is not limited to a straight flow path 64 and may comprise a curved, angled, or otherwise non-linear flow path 60. It is to be further understood that a first portion of the flow path 64 may be straight, and a second portion of the flow path 64 may be curved, for example. It is to be further understood that the instant inventive concept is not limited to a single flow path 64, and in some exemplary embodiments the separation chamber may define more than one flow path 64, as will be understood by persons of ordinary skill in the art.

The grooves 50 are shown to be similar in configuration to the grooves 22 described above in reference to the microfluidic device 10 with the exception that the first ends 52 and second ends 54 of the grooves 50 extend beyond the boundary of the capillary gap 44 so as to intersect the flush capillary 56 and the exit capillary 58. It is to be appreciated that while a single flush capillary 56 and a single flush port 60 are shown as being in fluid communication with the first ends 52 of four grooves 50 in FIGS. 3 and 4, the instant inventive concept is not limited to such configuration. In some exemplary embodiments of the instant inventive concept, a single flush capillary 56 and a single flush port 60 may be in fluid communication with a single groove 50, with two grooves 50, or with more than two grooves 50. Further, in some exemplary embodiments of the instant inventive concept, a first flush capillary 56 and a first flush port 60 may be in fluid communication with one or more first grooves 50, and a second flush capillary 56 and a second flush port 60 may be in fluid communications with one or more second grooves 50.

The flush capillary 56, the one or more grooves 50, and the exit capillary 58 cooperate to define a second flow path 66. The second flow path 66 is perpendicular to the first flow path 64, and functions to allow for the flushing of captured cells 70 as will be described below.

The operation of the microfluidic device 10a is shown in FIG. 4. A bulk fluid 68 containing one or more cells 70 is fed into the inlet port 42a and flows across the capillary gap 44 via the first flow path 66. The first bulk fluid 68 has a first bulk fluid 68 surface energy, and the one or more cells 70 have a second surface energy. It is to be understood that in some exemplary embodiments of the instant inventive concept, the first surface energy of the bulk fluid 68 may be adjusted to equal or approximate the second surface energy of the one or more cells 70, for example. In other exemplary embodiments, however, the first surface energy and the second surface energy may differ, and may be related to one another via a predetermined ratio, for example. Desirably, the surface energy of the bulk fluid 68 and/or of the one or more cells 70 is lower than the surface energy of the capillary gap 44 and/or the one or more grooves 50. In other words, the surface energy of the grooves 50 is desirably higher than the surface energy of the cells 70 and of the bulk fluid 68, to endure that cells 70 are attracted to, and adhere into, the groove 50.

As the first bulk fluid 68 flows through the capillary gap 44 one or more of the cells 70 are captured inside one or more of the grooves 50 (such as by adhering inside the one or more groves 50, for example), and the first bulk fluid 68 exits the microfluidic device 10a via outlet port 42b. It is to be understood that some or all of the one or more cells 70 may be captured and/or removed from the first bulk fluid 68 as the first bulk fluid 68 is passed through the microfluidic device 10a. For example, an amount between 0% and 100% of the one or more cells 70 present in the first bulk fluid 68 may be captured and/or removed in each passing of the fluid 68 through the microfluidic device 10a as described above.

Next, a flush fluid 72 is passed into the microfluidic device 10a via the flush port 56 that is in fluid communication with grooves 50. The flush fluid 72 desirably has a surface energy which is higher than the surface energy of the grooves 50, such that one or more cells 70 cease to adhere into the groove 50 and are flushed away from one or more grooves 50 by the flush fluid 72. It is to be understood however, that the flush fluid 72 may have a surface energy similar, or equal to, the surface energy of the grooves 50, for example. The flush fluid 72 flushes cells 70 via a second flow path 66, and out of the capillary gap 44 and the microfluidic device 10a via the exit port 58.

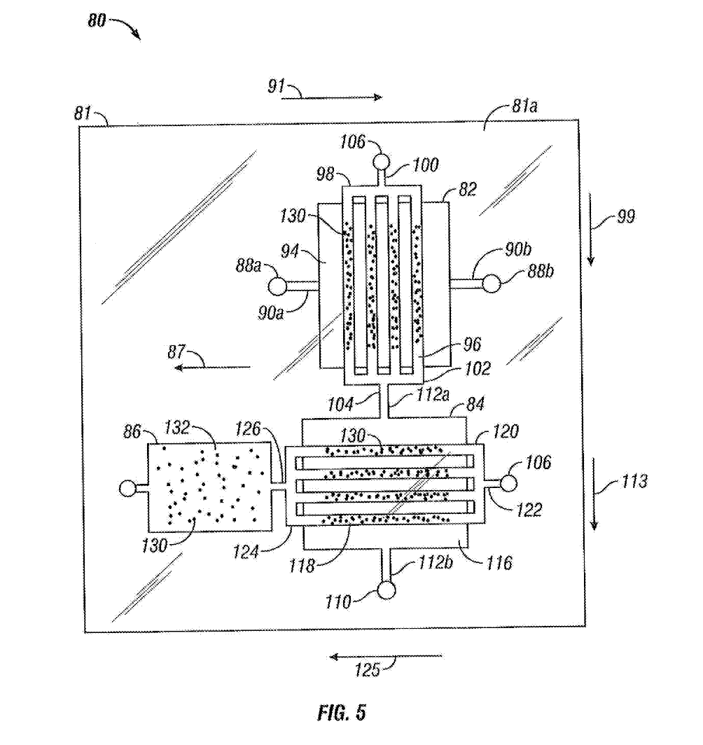

Referring now to FIG. 5, another embodiment of a microfluidic device 80 adapted for sequential processing of cells is shown. The microfluidic device 80 comprises a base portion 81 provided with a first capillary gap 82, a second capillary gap 84 in fluid communication with the first capillary gap 82, and a third capillary gap 86 in fluid communication with the second capillary gap 84.

The first capillary gap 82 can be implemented similarly to microfluidic device 10a above and comprises an inlet port 88a, an outlet port 88b, an inlet capillary 90a, a bottom surface 94 with one or more grooves 96 formed therein, and an outlet capillary 90b. The grooves 96 comprise a first end 98 in fluid communication with a flush capillary 100 and a second end 102 in fluid communication with an exit capillary 104. The flush capillary 100 is in fluid communication with a flush port 106, and the exit capillary 104 is in fluid communication the second capillary gap 84. The inlet capillary 90a, the capillary gap 82, and the outlet capillary 90b cooperate to define a first flow path 91 which is perpendicular to the one or more grooves 96. The flush capillary 100, the one or more grooves 96, and the exit capillary 104 cooperate to define a second flow path 99 which is perpendicular to the first flow path 91.

The second capillary gap 84 can likewise be implemented similarly to microfluidic device 10a above, and comprises an outlet port 110, an inlet capillary 112a, a bottom surface 116 with one or more grooves 118 formed therein, and an outlet capillary 112b. The grooves 118 comprise a first end 120 in fluid communication with a flush capillary 122 and a second end 124 in fluid communication with an exit capillary 126. The flush capillary 122 is in fluid communication with a flush port 106, and the exit capillary 104 is in fluid communication the third capillary gap 86. The inlet capillary 112a, the capillary gap 84, and the outlet capillary 112b cooperate to define a first flow path 113, which is perpendicular to the one or more grooves 118. The flush capillary 122, the one or more grooves 118, and the exit capillary 126 cooperate to define a second flow path 125 which is perpendicular to the first flow path 113.

The third capillary gap 86 is an optional feature and comprises a bottom surface 132 adapted to allow a scanning microscope to capture one or more images of the capillary gap 84 and any flush fluid 128 and/or cells 130 contained therein. The third capillary gap 86 is in fluid communication with the second capillary gap 84 via a capillary 134, and comprises an outlet capillary 136. The capillary 134, third capillary gap 86, and the outlet capillary 136 define a flow path 87. The third capillary gap 86 desirably has a transparent portion formed therein, as will be apparent to a person of ordinary skill in the art presented with the instant disclosure. The third capillary gap 86 may be implemented as a conventional imaging area and may be imaged with a conventional scanning microscope and using conventional imaging and image processing methods, for example.

In operation, a bulk fluid 128 comprising one or more cells 130 is passed through the first capillary gap 82 as described above with reference to microfluidic device 10a, via the first fluid path 91. The bulk fluid 128 has a bulk fluid surface energy, and the one or more cells 130 have a cell surface energy which is desirably the same as, or similar to, the bulk fluid surface energy. The one or more cells 130 are separated from the bulk fluid 128 and adhere inside one or more of the grooves 96. The bulk fluid 128 exits the first capillary gap 82 via outlet port 88b.

Next, a second fluid is passed through the first capillary gap 82 along the second fluid path 99 such that one or more cells 130 are flushed from the one or more grooves 96 via exit capillary 104 and into the second capillary gap 84 via inlet capillary 112a. The second fluid may be any fluid, such as a wash fluid, a buffer fluid, a staining fluid, a detection reagent fluid, a biomarker, and combinations thereof, for example. The second fluid desirably has a surface energy lower than the surface energy of the bottom surface 116 of the second capillary gap 84.

The second fluid carries one or more cells 130 into the second capillary gap 84 via the flow path 113, such that the cells 130 adhere into one or more of the grooves 118. The second fluid exits the second capillary gap 84 via outlet port 110.

Next, a third fluid is passed through the second capillary gap 84 along flow path 125, such that one or more cells 130 are flushed out of the one or more grooves 118 and into the third capillary gap 86. The one or more cells 130 desirably adhere to the bottom surface 132 of the third capillary gap 86 and may be further processed or imaged, for example. The third fluid exits the third capillary gap 86 via an outlet capillary 136.

In some exemplary embodiments of the instant inventive concept, the third capillary gap 86 may be omitted, or may not be in fluid communication with the second capillary gap 84, for example. In such exemplary embodiments, the cells 130 may be removed from the second capillary gap 84 for additional processing, and may only then be transferred into a third capillary gap 86 for imaging or further processing.

In one exemplary embodiment, a third capillary gap 86 comprises an imaging area of 8 mm by 8 mm and a 0.5 mm capillary gap which holds 150 μl of fluid. In this exemplary embodiment, the ratio of capillary gap height to WBC diameter is 50. This area contains 6000 high powered field images at 400× magnification. In a sample containing 2,000,000 cells 130 there would be approximately 333 cells 130 per image, or a packing ratio of 0.05%. Packing ratio is calculated as the number of cells 130 in the image area over maximum number of cells 130 that could be captured on the bottom surface of the third capillary gap 86. The higher the packing ratio, the more likely it is that cells 130 will overlap and image quality will be reduced. Generally, packing ratios greater than 40% are desirable. For this image area, a packing ratio of 20.83% would be achieved with a sample of about 800,000,000 cells 130.

It is to be understood that the sequential microfluidic device 80 may also be implemented as comprising two or more microfluidic devices 10a in fluid communication with one another, such that the flush capillary 56 of a first microfluidic device 10a is in fluid communication with the inlet capillary 42a of a second microfluidic device 10, and a first flow path 64 of the first microfluidic device 10a is perpendicular to a second flow path 64 of the second microfluidic device 10a, for example.

It is to be understood that while a sequential microfluidic device 80 is shown as having three capillary gaps, the instant inventive concept is not limited to three capillary gaps, and may be implemented as a sequential device 80 comprising one, two, three, four, or more capillary gaps, for example. It is to be further understood that the orientation of a first flow path of a first capillary gap relative to a first flow path of a second capillary gap is immaterial for the functioning of a sequential microfluidic device 80, so long as the first capillary gap comprises a first flow path and a second flow path perpendicular to one another, and the second capillary gap comprises a first flow path and a second flow path perpendicular to one another.

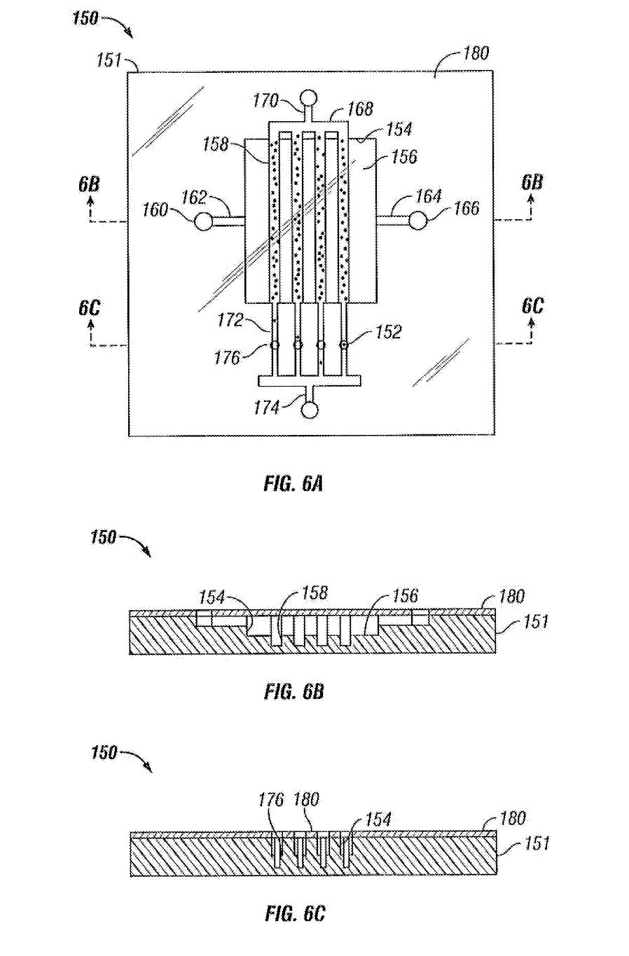

Referring now to FIGS. 6A-6C, shown therein is an exemplary embodiment of a microfluidic device 150 adapted for the isolation of a single cell 152. The microfluidic device 150 may be implemented similarly to microfluidic device 10 and comprises a base portion 151 and a top portion 180. The base portion 151 is provided with a capillary gap 154 having a bottom surface 156 provided with one or more grooves 158. The microfluidic device 150 further comprises an inlet port 160, an inlet capillary 162, an outlet capillary 164, and an outlet port 166.

The one or more grooves 158 further comprise a surface energy, a width, and a depth, a first end 168 in fluid communication with a flush capillary 170, and a second end 172 in fluid communication with an exit capillary 174. The second end 172 further comprises an isolation port 176.

The isolation port 176 comprises a capillary having a diameter which is approximately equal to the diameter of the one or more cells 152. As used herein approximately equal is intended to include but not be limited to, equal to, slightly larger than, or slightly smaller than the diameter of the one or more cells 152. As will be understood by a person of ordinary skill in the art, such configuration would allow for a single cell 152 to be isolated and removed from the isolation port 176. It is to be understood, however that in some embodiments an isolation port 176 according to the instant inventive concept may have varying diameters, such as approximately twice the diameter of the one or more cells 152, or any other desired diameter without regard to the diameter of the one or more cells 152.

In operation, the microfluidic device 150 operates similarly to the microfluidic device 10, except that one or more cells 152 may be removed via the isolation port 176, desirably one cell 152 at a time, rather than being flushed out of the exit capillary 174.

As will be understood by persons of ordinary skill in the art, in some exemplary embodiments the isolation port 176 may extend through the top portion 180 sealing the capillary gap 154, as shown in FIG. 6C. The diameter of the isolation port 176 may be adjusted depending on the diameter of the one or more cells 152 and may be dependent on the concentration of the one or more cells 152 in the sample. As the samples are more diluted, the size or diameter of the isolation port 176 can be larger and more fluid may be removed with each cell 152.

From the above description, it is clear that the inventive concept(s) disclosed herein is well adapted to carry out the objects and to attain the advantages mentioned herein as well as those inherent in the inventive concept disclosed herein. While presently preferred embodiments of the inventive concept disclosed herein have been described for purposes of this disclosure, it will be understood that numerous changes may be made which will readily suggest themselves to those skilled in the art and which are accomplished without departing from the scope of the inventive concept disclosed herein and defined by the appended claims.

What is claimed is:

1. A microfluidic device for separating one or more cells having a diameter and a first surface energy from a bulk fluid having a second surface energy, the microfluidic device comprising:
a base portion having a capillary gap with an inlet capillary, an outlet capillary, a bottom surface, a gap height with the ratio of the gap height to the diameter of the one or more cells ranging from 5 to 1 to 100 to 1, and defining a first flow path therethrough, at least one groove formed in the bottom surface of the capillary gap, the at least one groove having a depth, a width, and a third surface energy, and oriented perpendicular relative to the first flow path,
wherein the ratio of the groove width to the diameter of the one or more cells ranges from about 5 to 1 to about 100 to 1, and wherein the third surface energy is higher than the first and second surface energies.

2. The microfluidic device of claim 1, wherein the at least one groove further comprises a first end and a second end, and wherein the base portion has a feed capillary in fluid communication with the first end and an exit capillary in fluid communication with the second end of the at least one groove such that a flush fluid is able to flow through the feed capillary, the at least one groove, and the exit capillary.

3. The microfluidic device of claim 1, wherein the at least one groove is substantially free from affinity reagents.

4. The microfluidic device of claim 2, wherein the second end of the at least one groove further comprises an isolation port having a capillary with a diameter approximately equal to the diameter of the one or more cells.

5. The microfluidic device of claim 1, wherein the first surface energy is equal to the second surface energy.

6. The microfluidic device of claim 1, wherein the third surface energy is a hydrophilic surface energy.

7. A method for separating one or more cells having a diameter and a first surface energy from a bulk fluid having a second surface energy, comprising:
passing the bulk fluid through a microfluidic device comprising:
a capillary gap having an inlet capillary, an outlet capillary, a bottom surface, a gap height, and defining a first flow path therethrough; and
at least one groove formed in the bottom surface of the capillary gap, the at least one groove having, a width, and a third surface energy, and oriented perpendicular relative to the first flow path; and
wherein the ratio of the groove width to the diameter of the one or more cells ranges from about 5 to 1 to about 100 to 1, the ratio of the gap height to the diameter of the one or more cells ranges from about 5 to 1 to about 100 to 1, and wherein the third surface energy is higher than the first and second surface energies.

8. A microfluidic device system for separating one or more cells having a diameter and a first surface energy from a bulk fluid having a second surface energy, comprising:
a first capillary gap comprising an inlet capillary, an outlet capillary, a bottom surface, a gap height, and defining a first flow path therethrough;
at least one groove formed in the bottom surface of the first capillary gap, the at least one groove having a width, a first end, a second end, and a third surface energy, and oriented perpendicular relative to the first flow path;
a feed capillary in fluid communication with the first end of the at least one groove, and an exit capillary in fluid communication with the second end of the at least one groove;
a second capillary gap comprising an inlet capillary in fluid communication with the exit capillary of the first capillary gap, an outlet capillary, a bottom surface, a gap height, and defining a second flow path therethrough; and
at least one groove formed in the bottom surface of the second capillary gap, the at least one groove having a depth, a width, and a fourth surface energy, and oriented perpendicular relative to the second flow path,
wherein the first flow path is perpendicular relative to the second flow path and the fourth surface energy is higher than the first surface energy and the second surface energy.

9. The microfluidic device of claim 8, wherein the first surface energy is equal to the second surface energy.

10. The microfluidic device of claim 8, wherein the third surface energy is equal to the fourth surface energy.

11. The microfluidic device system of claim 8, further comprising a third capillary gap defining an imaging area in fluid communication with the second capillary gap.

12. A method for separating one or more cells having a diameter and a first surface energy from a sample fluid having a second surface energy, comprising:
introducing the sample fluid into a microfluidic device, via an inlet port, the microfluidic device comprising:
a capillary gap in fluid communication with the inlet port and having an outlet port, a bottom surface, a first flow path therethrough, and a gap height; and
at least one groove formed in the bottom surface of the capillary gap, the at least one groove having a depth, a width, and a third surface energy, and oriented substantially perpendicular to the first flow path,
wherein the ratio of the groove width to the diameter of the one or more cells ranges from about 5 to 1 to about 100 to 1 and the ratio of the groove height to the diameter of the one or more cells ranges from about 5 to 1 to about 100 to 1, and wherein the third surface energy is higher than the first and second surface energies;
passing the sample fluid into the capillary gap; and
removing the sample fluid from the capillary gap once the one or more cells have separated from the sample fluid.

13. The method of claim 12, wherein the at least one groove further comprises a first end and a second end, a flush capillary in fluid communication with the first end, and an exit capillary in fluid communication with the second end, and wherein a flush fluid having a fourth surface energy higher than the third surface energy is passed through the flush capillary, the at least one groove, and the exit capillary, such that the flush fluid can flush one or more separated cells from the at least one groove and out through the exit capillary.

14. A microfluidic device, comprising:
a base portion having a capillary gap with a first surface energy, the capillary gap comprising an inlet capillary, an outlet capillary, a bottom surface, a gap height, and defining a first flow path therethrough; and
at least one groove formed in the bottom surface of the capillary gap, the at least one groove having a depth, a width, and a second surface energy, and oriented substantially perpendicular relative to the first flow path,
wherein when one or more cells, having a third surface energy lower than the first and second surface energies and a diameter such that the ratio of the groove width to the diameter of the one or more cells ranges from about 5 to 1 to about 100 to 1 and the ratio of the gap height to the diameter of the one or more cells ranges from about 5 to 1 to about 100 to 1, are passed through the capillary gap, at least one of the one or more cells are captured into the one or more grooves.

15. The microfluidic device of claim 14, wherein the at least one groove is substantially free from affinity reagents.

16. The microfluidic device of claim 14, wherein the at least one groove further comprises a first end and a second end, and wherein the base portion has a feed capillary in fluid communication with the first end and an exit capillary in fluid communication with the second end of the at least one groove such that a flush fluid is able to flow through the feed capillary, the at least one groove, and the exit capillary.

17. The microfluidic device of claim 15, wherein the second end of the at least one groove further comprises an isolation port having a capillary with a diameter approximately equal to the diameter of the one or more cells.

18. The microfluidic device of claim 14, wherein the first surface energy is equal to the second surface energy.

19. The microfluidic device of claim 14, wherein the third surface energy is a hydrophilic surface energy.

20. A microfluidic device, comprising:
a base portion including:
an inlet capillary, a capillary gap with a bottom surface with a first surface energy, and an outlet capillary, the capillary gap having a gap height and defining a first flow path;
at least one groove formed in the bottom surface of the capillary gap, the at least one groove having a width, a first end, a second end, and a second surface energy, and oriented substantially perpendicular relative to the first flow path;
a feed capillary in fluid communication with the first end of the at least one groove, and an exit capillary in fluid communication with the second end of the at least one groove;
a second capillary gap in fluid communication with the exit capillary of the first capillary gap, the second capillary gap having a bottom surface having a third surface energy, a gap height, and defining a second flow path; and
at least one groove formed in the bottom surface of the second capillary gap, the at least one groove having a depth, a width, and a fourth surface energy, and oriented perpendicular relative to the second flow path,
wherein the first flow path is substantially perpendicular relative to the second flow path and the fourth surface energy is higher than the first surface energy and the second surface energy, and
wherein when a bulk fluid comprising one or more cells having a diameter and a surface energy lower that the first, second, third, and for the surface energy, is passed through the microfluidic device, one or more cells are captured into the one or more grooves when the ratio of the gap height to the diameter of the one or more cells is from about 5 to 1 to about 100 to 1, and the ratio of the gap width to the diameter of the one or more cells is from about 5 to 1 to about 100 to 1.

21. The microfluidic device of claim 20, wherein the first surface energy is equal to the second surface energy.

22. The microfluidic device of claim 21, wherein the third surface energy is equal to the fourth surface energy.

23. The microfluidic device system of claim 20, further comprising a third capillary gap defining an imaging area in fluid communication with the second capillary gap.
